(19) United States
(12) Patent Application Publication
(10) Pub. No.: US 2016/0154749 A1
(43) Pub. Date: Jun. 2, 2016

(54) COMPUTER HAVING BUFFERING CIRCUIT FOR HARD DISK DRIVE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/703,417

(22) Filed: May 4, 2015

(30) Foreign Application Priority Data
Nov. 28, 2014 (CN) 201410701505.0

(51) Int. Cl. G06F 13/16; G06F 1/32; G06F 13/42

(52) U.S. Cl. CPC G06F 13/1673; G06F 13/4234; G06F 1/3268

(57) ABSTRACT

A computer has a buffering circuit, a power supply circuit, and a controlling circuit. The computer can perform charging operations when the power supply circuit provides power terminals, and perform discharging operations when the power supply circuit powers off unexpected, to provide power to the controlling circuit. The controlling circuit can control the position of a disk head to the track zero of a disk platter of a hard disk drive.

### FIELD

The subject matter herein generally relates to a computer having a buffering circuit.

### BACKGROUND

A hard disk drive includes a plurality of disk heads and disk platters. When a computer operates, the hard disk drive of the computer can spin at 5400-7200 rpm. The disk head can be back to the outermost track (track zero) of the disk platter when the computer powers off normally. If the computer powers off unexpected, the disk head may not be able to move back to the outermost track of the disk platter.

### BRIEF DESCRIPTION OF THE DRAWINGS

Implementations of the present technology will now be described, by way of example only, with reference to the attached figures.

FIG. 1 is a block diagram of a first embodiment of a computer having a buffering circuit for a hard disk drive of the present disclosure.

FIG. 2 is a circuit diagram of the buffering circuit of FIG. 2.

FIG. 3 is a block diagram of a second embodiment of the computer.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The present disclosure is described in relation to a computer having buffering circuit for a hard disk drive (HDD).

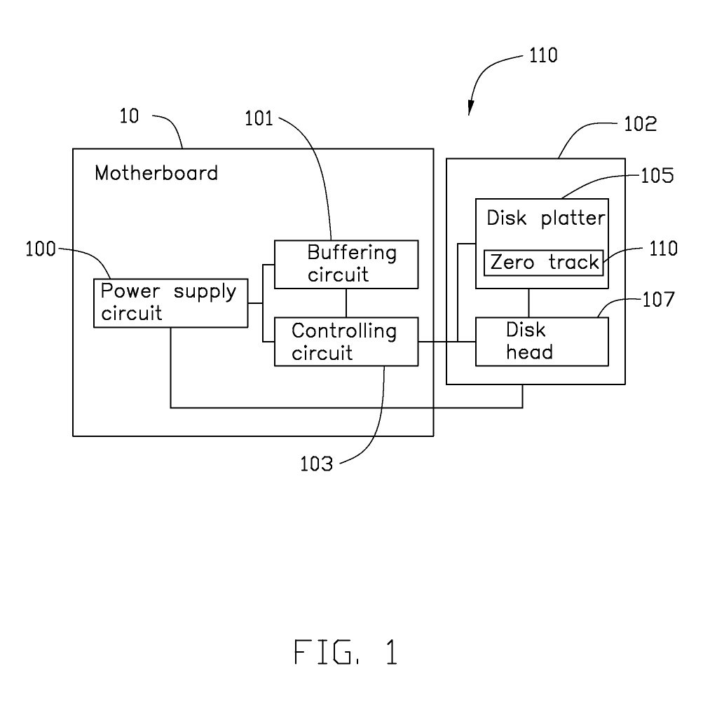

FIG. 1 illustrates a computer 110 that can comprise a motherboard 10 and a hard disk drive (HDD) 102. The motherboard 10 can comprise a power supply circuit 100, a buffering circuit 101, and a controlling circuit 103.

The power supply circuit 100 can provide various voltages, such as a 5 voltage (V), a 12V, and a 3V. The power supply circuit 100 can provide voltage to the HDD 102. In one embodiment, the HDD 102 is configured to perform read and/or write operation about data. The HDD 102 can comprise a disk head 107 and a disk platter 105. The disk head 107 can suspend a short distance over the disk platter 105 when the HDD 102 operates normally.

The controlling circuit 103 can receive the voltage from the power supply circuit 100, and control the operation of the disk head, to read or write data. In one embodiment, when the power supply circuit 100 powers off normally, the controlling circuit 103 can control the disk head 107 to move back to the outermost track (track zero) 110 of the disk platter 105.

The buffering circuit 101 can couple to the power supply circuit 100. The buffering circuit 101 can perform a charging operation when the power supply circuit 100 provides voltages, and perform a discharging operation when the power supply circuit 100 provides no voltage.

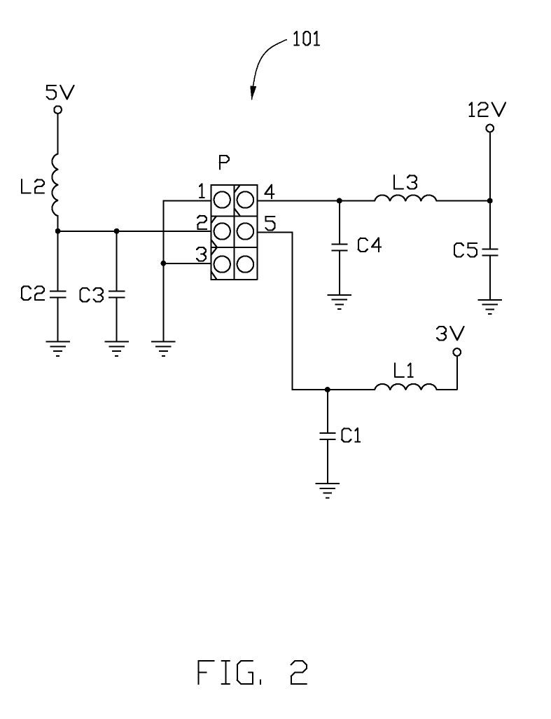

FIG. 2 illustrates that the buffering circuit 101 can comprise a connector P, five capacitors C1-C5, and three inductances L1-L3.

The connector P can comprise five pins 1-5. The pin 1 and pin 3 of the connector P is connected to ground, the pin 2 of the connector P is coupled to a 5V power terminal of the power supply circuit 100 through the inductance L2. The pin 2 of the connector P is connected to ground through the capacitors C2 and C3 in parallel connection. The pin 4 of the connector P is coupled to a 12V power terminal of the power supply circuit through the inductance L3, and is also connected to ground through the capacitor C5. The pin 5 of the connector P is coupled to a 3V power terminal of the power supply circuit 100 through the inductance L1, and is also connected to ground through the capacitor C1. In one embodiment, the 5V, 12V, and 3V power terminals are used to output the 5V power, 12V power, and 3V power respectively.

In one embodiment, when the power supply circuit 100 outputs the 3V power, the 5V power, and the 12V power, the capacitors C1, C2, and C3 of the buffering circuit 101 can perform the charging operations. When the power supply circuit 100 powers off unexpected, for example, the 3V, the 5V, and the 12V have no longer been provided by the power supply circuit 100, the capacitors C1, C2, and C3 of the buffering circuit 101 can perform discharging operations, to continually provide a control voltage to the controlling circuit 103. In one embodiment, the buffering circuit 101 can provide the control voltage for the controlling circuit 103 for a predetermined time, such as 250 milliseconds, after the power supply circuit 100 powers off unexpected. The controlling circuit 103 can control the disk head 107 to move to the outermost track (track zero) 110 of the disk platter 105 of the HDD 102.

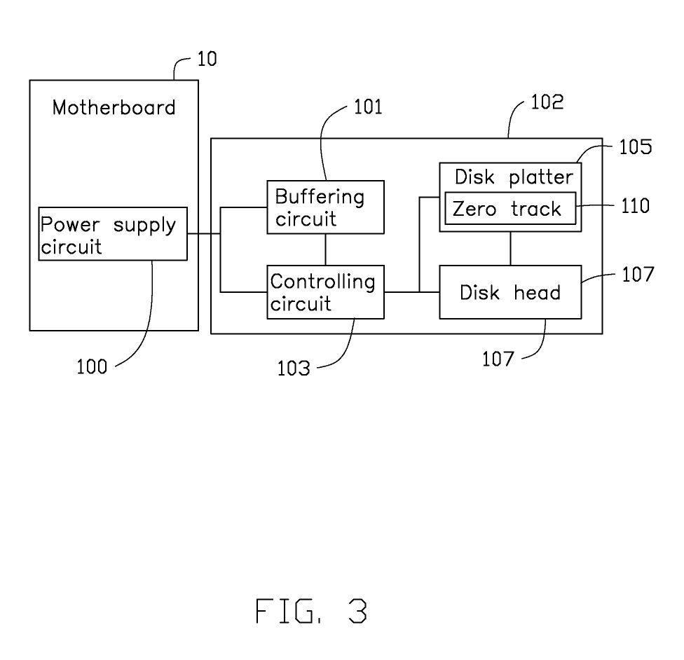

FIG. 3 illustrate a second embodiment of the computer 110. As comparing to the first embodiment, the buffering circuit 101 and the controlling circuit 103 are embedded or integrated in the HDD 102.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A motherboard, comprising:
a power supply circuit configured to provide a plurality of voltages;
a controlling circuit coupled to the power supply circuit and configured to control movement of a disk head of a hard disk drive; and
a buffering circuit coupled to the power supply circuit;
wherein when the power supply circuit outputs voltages, the buffering circuit performs a charging operation; when the power supply circuit outputs no voltage, the buffering circuit performs a discharging operation, thereby to provide a control voltage to the controlling circuit for a predetermined time; the controlling circuit receives the control voltage from the buffering circuit for controlling the disk head move to a track zero of a disk platter of the hard disk drive in the predetermined time.

2. The motherboard of claim 1, wherein the buffering circuit comprises a connector, a first pin of the connector is coupled to a first power terminal of the power supply circuit through a first inductance, the first pin is connected to ground through a first capacitor; a second pin of the connector is coupled to a second power terminal through a second conductance, the second pin of the connector is connected to ground through a second capacitor; a third pin of the connector is coupled to a third terminal through a third conductance, the third pin of the connector is connected to ground through a third capacitor.

3. The motherboard of claim 2, wherein the first pin of the connector is connected to ground through a fourth capacitor, the second power terminal is connected to ground through a fifth capacitor.

4. The motherboard of claim 3, wherein the predetermined time is 250 milliseconds.

5. A computer, comprising:
a hard disk drive comprising a disk platter and a disk head capable of suspending over the disk platter;
a motherboard, comprising:
a power supply circuit configured to provide a plurality of voltages;
a controlling circuit coupled to the power supply circuit, and configured to control operations of the disk head of hard disk drive; and
a buffering circuit coupled to the power supply circuit; wherein when the power supply circuit outputs voltages, the buffering circuit performs a charging operation, when the power supply circuit outputs no voltage, the buffering circuit perform a discharging operation, thereby to provide a control voltage to the controlling circuit for a predetermined time; when the controlling circuit receives the control voltage from the buffering circuit, the controlling circuit controls the disk head to move to a track zero of the disk platter of the hard disk drive.

6. The computer of claim 5, wherein the buffering circuit comprises a connector, a first pin of the connector is coupled to a first power terminal of the power supply circuit through a first inductance, the first pin is connected to ground through a first capacitor; a second pin of the connector is coupled to a second power terminal through a second conductance, the second pin of the connector is connected to ground through a second capacitor; a third pin of the connector is coupled to a third terminal through a third conductance, the third pin of the connector is connected to ground through a third capacitor.

7. The computer of claim 6, wherein the first pin of the connector is connected to ground through a fourth capacitor, the second power terminal is connected to ground through a fifth capacitor.

8. The computer of claim 7, wherein the predetermined time is 250 milliseconds.

9. A hard disk drive, comprising:
a disk platter;
a disk head capable of suspending over the disk platter;
a controlling circuit coupled to a power supply circuit, and configured to control operations of the disk head of hard disk drive; and
a buffering circuit coupled to the power supply circuit; wherein when the power supply circuit outputs a plurality of voltages, the buffering circuit performs a charging operation, when the power supply circuit outputs no voltage, the buffering circuit perform a discharging operation, thereby to provide a control voltage to the controlling circuit for a predetermined time; when the controlling circuit receives the control voltage from the buffering circuit, the controlling circuit controls the disk head to a track zero of the disk platter of the hard disk drive.

10. The hard disk drive of claim 9, wherein the buffering circuit comprises a connector, a first pin of the connector is coupled to a first power terminal of the power supply circuit through a first inductance, the first pin is connected to ground through a first capacitor; a second pin of the connector is coupled to a second power terminal through a second conductance, the second pin of the connector is connected to ground through a second capacitor; a third pin of the connector is coupled to a third terminal through a third conductance, the third pin of the connector is connected to ground through a third capacitor.

11. The hard disk drive of claim 10, wherein the first pin of the connector is connected to ground through a fourth capacitor, the second power terminal is connected to ground through a fifth capacitor.

12. The hard disk drive of claim 11, wherein the predetermined time is 250 milliseconds.
